(19) United States
(12) Patent Application Publication
(10) Pub. No.: US 2014/0193003 A1
(43) Pub. Date: Jul. 10, 2014

(54) PARASITIC ISOLATION COMMUNICATION SWITCH

(71) Applicant: Fairchild Semiconductor Corporation, San Jose, CA (US)

(72) Inventor: Nickole Gagne, Saco, ME (US)

(73) Assignee: Fairchild Semiconductor Corporation, San Jose, CA (US)

(21) Appl. No.: 14/053,277

(22) Filed: Oct. 14, 2013

Related U.S. Application Data
(60) Provisional application No. 61/750,594, filed on Jan. 9, 2013.

(51) Int. Cl. H02M 1/08

(52) U.S. Cl. CPC H02M 1/08
USPC 381/123; 327/333

(57) ABSTRACT

This document discusses, among other things, a switch multiplexer having a common connector, the switch multiplexer including a first switch configured to receive a first signal at or above a ground (GND) reference and a second switch configured to receive a second signal that swings positive and negative about ground. The switch multiplexer includes a negative charge pump configured to bias the first switch with a negative charge pump voltage lower than the most negative voltage swing of the second signal when the second switch is enabled, and to bias the first switch with GND when the first switch is enabled.

### CLAIM OF PRIORITY

This application claims the benefit of priority under 35 U.S.C. §119(e) of Nickole Gagne U.S. Provisional Patent Application Ser. No. 61/750,594, titled “METHOD OF PARASITIC ISOLATION IN COMMUNICATION SWITCHES WITH IMPROVED BANDWIDTH,” filed on Jan. 9, 2013, which is incorporated by reference herein in its entirety.

### BACKGROUND

Electronic devices commonly share a single output with multiple internal components. For example, a single universal serial bus (USB) port can be configured to send or receive USB information as well as send or receive one or more other type of information, such as audio information. Such dual use of a single port often requires separate circuits having at least some component redundancy.

FIG. 1 illustrates generally an existing combined USB and audio switch 100 (e.g., a switch multiplexer) including a USB pass gate 105 and an audio pass gate 110 configured to share a common connector (CON). In this example, each of the USB pass gate 105 and the audio pass gate 110 are coupled to separate control electronics, including separate level shift down components 106,111 and separate under voltage tolerance (UVT) networks 107,112.

### Overview

This document discusses, among other things, a switch multiplexer having a common connector, the switch multiplexer including a first switch configured to receive a first signal at or above a ground (GND) reference and a second switch configured to receive a second signal that swings positive and negative about GND. The switch multiplexer includes a negative charge pump configured to bias the first switch with a negative charge pump voltage lower than the most negative voltage swing of the second signal when the second switch is enabled, and to bias the first switch with GND when the first switch is enabled.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a combined universal serial bus (USB) and audio switch.

FIG. 2 illustrates generally an example negative charge pump circuit.

FIG. 3 illustrates generally a combined USB and audio switch according to the present subject matter.

FIG. 4 illustrates generally a plot of bandwidth performance versus frequency for various switch examples.

### DETAILED DESCRIPTION

The present inventor has recognized, among other things, a system and method capable of reducing component redundancy in multi-use pass gates sharing a common connector. In an example, a negative charge pump, providing an output with a magnitude less than the most negative switch node voltage (−VSW) in a system, can be enabled in a switch only during modes that require a negative switch voltage. In an example, the switch can have a first mode, such as a USB mode, where the switch voltage remains above GND, and a second mode, such as an audio mode, where the switch voltage goes below GND. In the first mode, where the switch voltage remains above GND, the negative charge pump can provide an output at GND potential. In the second node, where the switch voltage goes below GND, the negative charge pump can provide an output with a magnitude less than the most negative switch node voltage (−VSW) in the system.

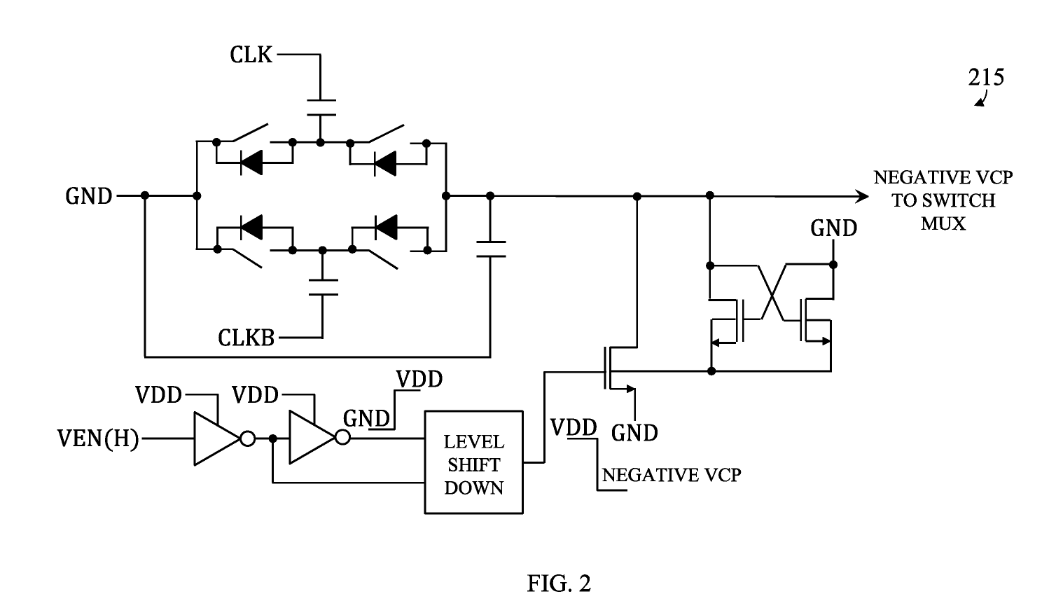

FIG. 2 illustrates generally an example negative charge pump circuit 215 configured to generate a negative charge pump voltage (−VCP) in response to receiving an enable signal (e.g., when VEN is high (H), etc.) and to generate GND in response to receiving a disable signal (e.g., when VEN is low (L), etc.). The magnitude of the negative charge pump output (−VCP) of the negative charge pump circuit 215 is designed to be less than the most negative switch node voltage (−VSW) in a system including the negative charge pump circuit 215.

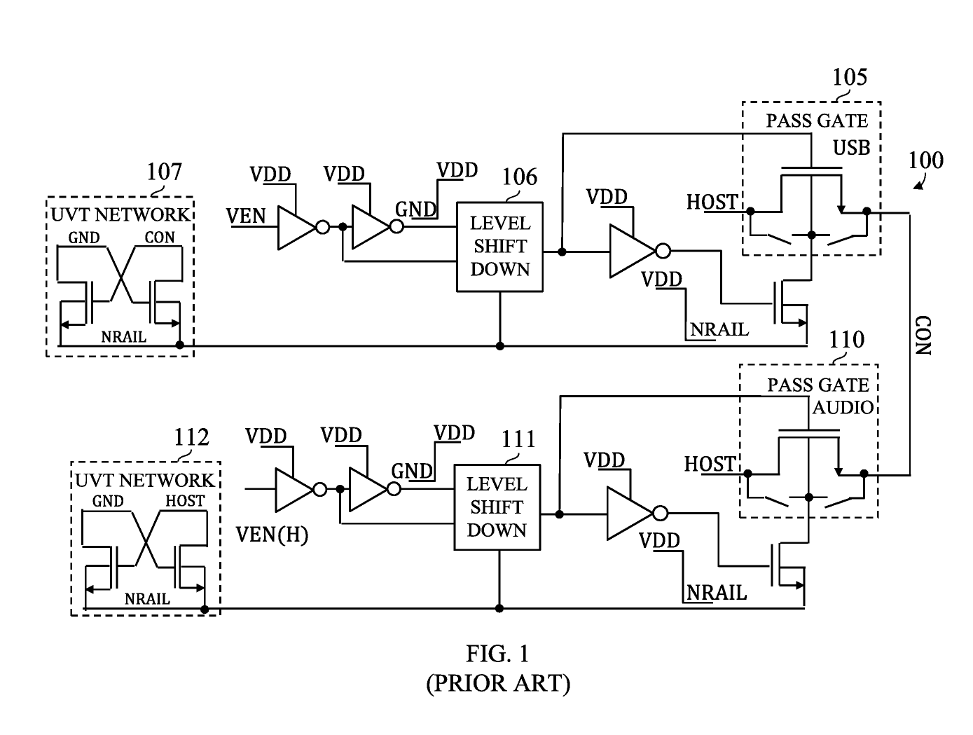

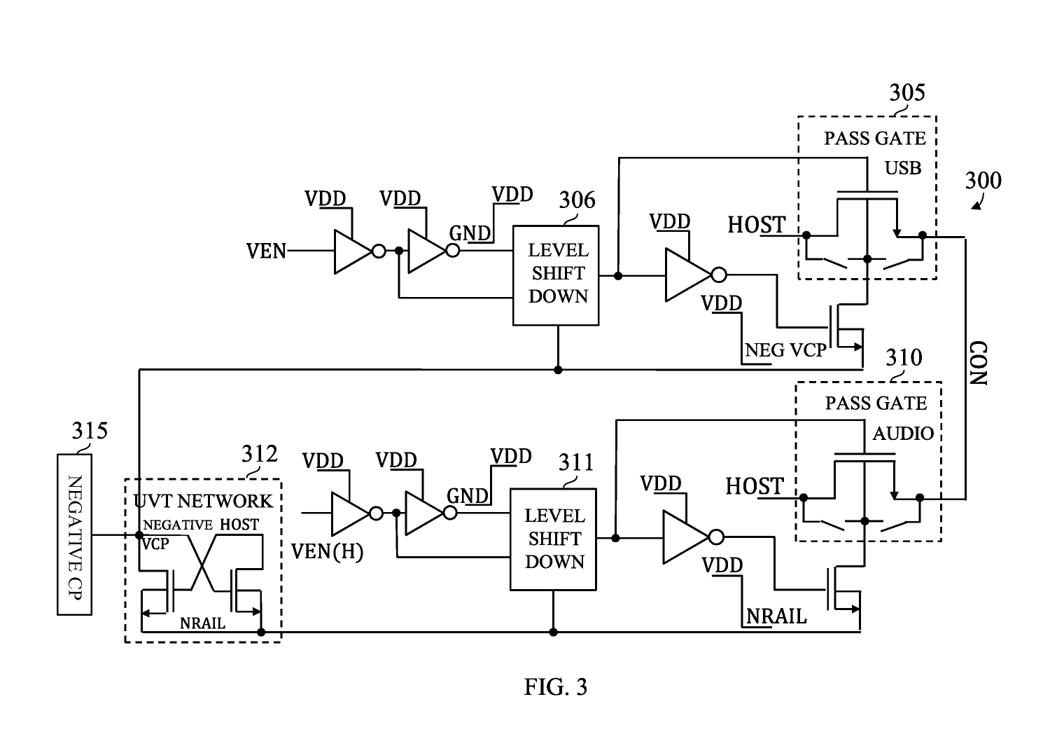

FIG. 3 illustrates generally a combined USB and audio switch 300 (e.g., a switch multiplexer) according to the present subject matter, including a USB pass gate 305 and an audio pass gate 310 configured to share a common connector (CON). In an example, the audio pass gate 310 can be replaced or added to using one or more other communication, video, or other switches configured to pass a signal configured to swing above and below GND, or in certain examples, at or below GND. In an example, the common connector (CON) can include an input or output port on an electronic device, such as a USB port, etc. In this example, each of the USB pass gate 305 and the audio pass gate 310 are coupled to separate control electronics, including separate level shift down components 306,311. However, in contrast to the example illustrated in FIG. 1, the combined USB and audio switch 300 includes a single UVT network 312 and a negative charge pump 315 (e.g., such as that illustrated in the example of FIG. 2).

When enabled (e.g., in audio mode, etc.), a negative charge pump 315 (e.g., such as that illustrated in the example of FIG. 2) can be used to bias a negative voltage reference for the gate control circuitry of the OFF switches (e.g., in audio mode, the parasitic diodes of the USB pass gate), for example, to ensure that the OFF switches do not bias with negative switch node voltage (−VSW) on the CON. In an example, when enabled, the negative charge pump can be configured to provide a negative charge pump voltage (−VCP) lower than the remaining voltages in the system (e.g., lower than the most negative switch node voltage, etc.) and can be used to generate a negative voltage reference for the OFF switches (e.g., USB, UART, KIT, MHL, etc.) sharing the CON with the negative voltage capable switch (e.g., audio, etc.). In certain examples, the negative charge pump voltage (−VCP) can be used to reverse bias all parasitic body diodes of the OFF switches to, among other things, ensure that a negative switch voltage on the CON will not bias a parasitic body diode in the pass gates or other components in the system. When disabled (e.g., in USB mode, etc.), the negative charge pump can be configured to provide a voltage at GND (e.g., by electrically shorting the output to GND), and a single under voltage tolerance (UVT) network can be used for both the USB pass gate 305 and the audio pass gate 310. Thus, in contrast to the example illustrated in FIG. 1, an under voltage tolerance (UVT) network (e.g., such as the UVT Network 107 illustrated in FIG. 1) on the CON can be removed. The reduction in UVT networks allows for a reduction in CON capacitance and a direct increase in available bandwidth in the system.

In an example, the function of the UVT networks can be provided by the negative charge pump, and the UVT networks, as illustrated in the example of FIG. 2, can be removed in every OFF switch, leading to a reduction in capacitance on the CON and a direct increase in bandwidth. In certain examples, a single UVT network can be required on a HOST side of a negative swing capable switch, or any other port capable of seeing the negative switch node voltage (−VSW) without power to the system. The CON can only see −VSW if the negative swing capable switch is enabled, in which case the negative charge pump will be enabled, isolating all OFF switches.

In this example, the USB pass gate 305 is a first pass gate and the audio pass gate 310 is a second pass gate. In certain examples, one or more other types of gates can be used with the systems and methods disclosed herein.

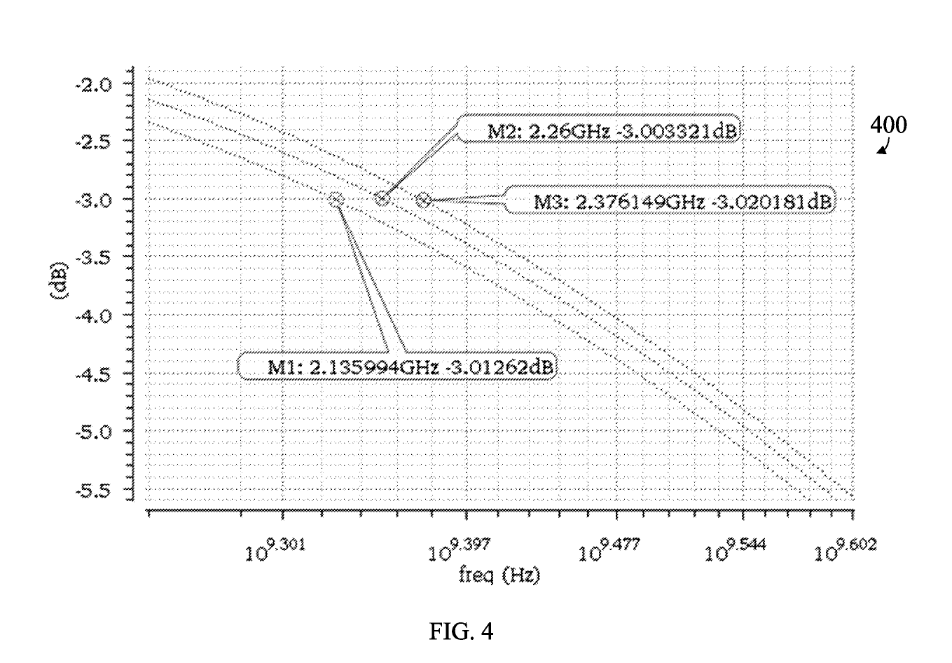

FIG. 4 illustrates generally a plot 400 of bandwidth performance versus frequency for various switch examples. The first line, Ml, illustrates the bandwidth performance of a switch MUX such as illustrated in the example of FIG. 1. The second line, M2, illustrates the bandwidth performance of a switch MUX with a single under voltage tolerance (UVT) network on a common connector (CON) (e.g., one UVT network replaced with a negative charge pump), such as that illustrated in the example of FIG. 3. In the example of FIG. 3, a single UVT is illustrated on the CON. However, many switch MUX circuits include electrostatic discharge (ESD) circuitry coupled to the CON (not illustrated in the example of FIGS. 1 and 3), and many ESD circuits include one or more UVT networks. In an example, each UVT network on the CON, including those in the ESD circuitry, can be replaced with a negative charge pump. The third line, M3, illustrates the bandwidth performance of a switch MUX with no UVT networks on the CON, which led to an increase in bandwidth of about 240 MHz, an increase of about 11%, to an MHL switch sharing the CON.

### Additional Notes

In Example 1, a system includes a switch multiplexer (MUX) having a common connector, the switch MUX including a first switch configured to receive a first signal, wherein the first signal is at or above a ground (GND) reference, and a second switch configured to receive a second signal, wherein the second signal swings positive and negative about GND. The system of Example 1 further includes a negative charge pump configured to bias the first switch with a negative charge pump voltage lower than the most negative voltage of the second signal when the second switch is enabled, and to bias the first switch with GND when the first switch is enabled.

In Example 2, the first signal of Example 1 optionally remains at or above GND.

In Example 3, the first switch of any one or more of Examples 1-2 optionally includes a universal serial bus (USB) switch and wherein the first signal includes a USB signal configured to remain at or above GND.

In Example 4, the second switch of any one or more of Examples 1-3 optionally includes at least one of an audio switch, a communication switch, or a video switch.

In Example 5, the second switch of any one or more of Examples 1-4 optionally includes an audio switch. In Example 6, the second switch of any one or more of Examples 1-5 is optionally configured to be coupled to a second level shift component and to an under voltage tolerance (UVT) network, wherein the UVT network is configured to provide the lower of the negative charge pump voltage and an input to the second switch, wherein the first switch of any one or more of Examples 1-5 is optionally configured to be coupled to a first level shift down component and to the negative charge pump voltage.

In Example 7, the first switch of any one or more of Examples 1-6 optionally includes parasitic body diodes, and wherein the negative charge pump is configured to reverse bias, when the second switch is enabled, the parasitic body diodes of the first switch.

In Example 8, the common connector of any one or more of Examples 1-7 is coupled to a USB port of an electronic device.

In Example 9, a method includes receiving a first signal at a first switch, wherein the first signal is configured to be at or above a ground (GND) reference, receiving a second signal at a second switch, wherein the second signal is configured to swing positive and negative about GND, biasing the first switch with a negative charge pump voltage lower than the most negative voltage of the second signal using a negative charge pump when the second switch is enabled, and biasing the first switch with GND using the negative charge pump when the first switch is enabled.

In Example 10, the first signal of any one or more of Examples 1-9 optionally remains at or above GND.

In Example 11, the first switch of any one or more of Examples 1-10 optionally includes a universal serial bus (USB) switch and the first signal of any one or more of Examples 1-10 optionally includes a USB signal configured to remain at or above GND.

In Example 12, the second switch of any one or more of Examples 1-11 optionally includes at least one of an audio switch, a communication switch, or a video switch.

In Example 13, the second switch of any one or more of Examples 1-12 optionally includes the audio switch.

In Example 14, any one or more of Examples 1-13 optionally includes coupling the second switch between a second level shift component and an under voltage tolerance (UVT) network, wherein the UVT network is configured to provide the lower of the negative charge pump voltage and an input to the second switch and coupling the first switch between a first level shift down component and the negative charge pump voltage.

In Example 15, the first switch of any one or more of Examples 1-14 optionally includes parasitic body diodes, and any one or more of Examples 1-14 optionally includes reverse biasing the parasitic body diodes of the first switch when the second switch is enabled.

In Example 16, the common connector of any one or more of Examples 1-15 is optionally coupled to a USB port of an electronic device.

In Example 17, a system or apparatus can include, or can optionally be combined with any portion or combination of any portions of any one or more of Examples 1-16 to include, means for performing any one or more of the functions of Examples 1-16, or a machine-readable medium including instructions that, when performed by a machine, cause the machine to perform any one or more of the functions of Examples 1-16.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document, for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A system comprising:
a switch multiplexer (MUX) having a common connector, the switch MUX including:
a first switch configured to receive a first signal, wherein the first signal is at or above a ground (GND) reference; and
a second switch configured to receive a second signal, wherein the second signal swings positive and negative about GND;
a negative charge pump configured to bias the first switch with a negative charge pump voltage lower than the most negative voltage of the second signal when the second switch is enabled, and to bias the first switch with GND when the first switch is enabled.

2. The system of claim 1, wherein the first signal remains at or above GND.

3. The system of claim 1, wherein the first switch includes a universal serial bus (USB) switch, and
wherein the first signal includes a USB signal configured to remain at or above GND.

4. The system of claim 1, wherein the second switch includes at least one of an audio switch, a communication switch, or a video switch.

5. The system of claim 1, wherein the second switch includes an audio switch.

6. The system of claim 1, wherein the second switch is configured to be coupled to a second level shift component and to an under voltage tolerance (UVT) network, wherein the UVT network is configured to provide the lower of the negative charge pump voltage and an input to the second switch, and
wherein the first switch is configured to be coupled to a first level shift down component and to the negative charge pump voltage.

7. The system of claim 1, wherein the first switch includes parasitic body diodes, and wherein the negative charge pump is configured to reverse bias, when the second switch is enabled, the parasitic body diodes of the first switch.

8. The system of claim 1, wherein the common connector is coupled to a USB port of an electronic device.

9. A method comprising:
receiving a first signal at a first switch, wherein the first signal is configured to be at or above a ground (GND) reference;
receiving a second signal at a second switch, wherein the second signal is configured to swing positive and negative about GND;
biasing the first switch with a negative charge pump voltage lower than the most negative voltage of the second signal using a negative charge pump when the second switch is enabled; and
biasing the first switch with GND using the negative charge pump when the first switch is enabled.

10. The method of claim 9, wherein the first signal remains at or above GND.

11. The method of claim 9, wherein the first switch includes a universal serial bus (USB) switch, and
wherein the first signal includes a USB signal configured to remain at or above GND.

12. The method of claim 9, wherein the second switch includes at least one of an audio switch, a communication switch, or a video switch.

13. The method of claim 9, wherein the second switch includes the audio switch.

14. The method of claim 9, including:
coupling the second switch between a second level shift component and an under voltage tolerance (UVT) network, wherein the UVT network is configured to provide the lower of the negative charge pump voltage and an input to the second switch; and
coupling the first switch between a first level shift down component and the negative charge pump voltage.

15. The method of claim 9, wherein the first switch includes parasitic body diodes, and, wherein the method includes:
reverse biasing the parasitic body diodes of the first switch when the second switch is enabled.

16. The method of claim 9, wherein the common connector is coupled to a USB port of an electronic device.
